(19) United States
(12) Patent Application Publication
(10) Pub. No.: US 2025/0094522 A1
(43) Pub. Date: Mar. 20, 2025

(54) METHOD AND SYSTEM FOR CONSTRAINED TIME SERIES GENERATION

(71) Applicant: JPMorgan Chase Bank, N.A., New York, NY (US)

(72) Inventors: Andrea COLETTA, Ferentino (IT); Sriram GOPALAKRISHNAN, West New York, NY (US); Daniel BORRAJO, Pozuelo de Alarcon (ES); Svitlana VYETRENKO, Colts Neck, NJ (US)

(73) Assignee: JPMorgan Chase Bank, N.A., New York, NY (US)

(21) Appl. No.: 18/368,365

(22) Filed: Sep. 14, 2023

(51) Int. Cl. G06F 17/11

(52) U.S. Cl. CPC G06F 17/11

(57) ABSTRACT

A method and a system for generating synthetic time series data that is subject to various types of constraints are provided. The method includes: receiving first information that relates to a sample of a historical time series and second information that relates to constraints; obtaining a set of synthetic time series based on the first information and the second information; calculating a set of distances of respective differences between the historical time series and each of the set of synthetic time series; and selecting, from among the set, a first synthetic time series for which a corresponding distance is a maximum. The set of synthetic time series may be obtained by using a Sequential Least Squares Programming algorithm or by using a diffusion model that is trained according to a defined protocol.

### BACKGROUND

### 1. Field of the Disclosure

This technology generally relates to methods and systems for generating time series data, and more particularly to methods and systems for generating synthetic time series data that is subject to various types of constraints.

### 2. Background Information

In recent years, synthetic time series have gained popularity in various applications such as data augmentation, forecasting, and imputation of missing values. Additionally, synthetic time series are very useful for generating unseen and counterfactual scenarios, where hypotheses and algorithms can be tested before being employed in real settings. For example, in financial markets, it may be useful to test trading strategies on hypothetical market scenarios, as poorly tested algorithms can lead to large losses for investors, as well as to overall market instability. In order to be useful, such hypothetical market stress scenarios need to be realistic—i.e., the synthetic market time series need to have statistical properties that are similar to the historical ones. They also need to satisfy certain constraints supplied by experts on how hypothetical market shock scenarios can potentially unfold. For instance, in order to ensure financial market stability, the US Federal Reserve annually assesses the market conditions and publishes a set of constrained market stress scenarios that financial institutions must subject their portfolios to, in order to estimate and adjust for their losses in case of market downturns.

Existing work employs deep generative models (DGMs) to capture the statistical data properties and temporal dynamics of time series, and additional constraints are usually introduced by penalizing the generative model proportionally to the mass it allocates to invalid data; or by adding a regularization term to the loss function. Other approaches condition the generative process by encoding constraints and feeding them into the model; or they reject and re-sample time series that do not match the constraints. A different line of work proposes special-purpose solutions, with ad-hoc architectures or sampling methods, which however take specific applications (not time series generation). In general, while most of these models are able to reproduce the real data statistics, complex constraints can still be challenging to be guaranteed. Most importantly, as DGMs incorporate constraints during training, a change to the constraints may require re-training because the learned distribution of a DGM may no longer cover the target distribution, and thus even rejection sampling would not be effective.

Accordingly, there is a need for a mechanism for generating synthetic time series data that is subject to various types of constraints.

### SUMMARY

The present disclosure, through one or more of its various aspects, embodiments, and/or specific features or sub-components, provides, inter alia, various systems, servers, devices, methods, media, programs, and platforms for methods and systems for generating synthetic time series data that is subject to various types of constraints.

According to an aspect of the present disclosure, a method for generating synthetic time series data is provided. The method is implemented by at least one processor. The method includes: receiving, by the at least one processor, first information that relates to a sample of a first historical time series and second information that relates to at least one constraint; obtaining, by the at least one processor, a plurality of synthetic time series based on the first information and the second information; calculating, by the at least one processor, a set of distances of respective differences between the first historical time series and each respective one of the plurality of synthetic time series; and selecting, by the at least one processor from among the plurality of synthetic time series, a first synthetic time series for which a corresponding distance is a maximum among the calculated set of distances.

The at least one constraint may include at least one from among a trend constraint, a final value constraint, a global minimum constraint, and a multivariate constraint that relates to maximum and minimum values of each of a high dimension and a low dimension of the plurality of synthetic time series.

The obtaining of the plurality of synthetic time series may include generating each respective one of the plurality of synthetic time series by using a Sequential Least Squares Programming algorithm.

According to another aspect of the present disclosure, a method for generating synthetic time series data is provided. The method is implemented by at least one processor. The method includes: receiving, by the at least one processor, first information that relates to a sample of a first historical time series and second information that relates to at least one constraint; adding Gaussian noise to the sample of the first historical time series in order to generate a first plurality of noisy samples; training a diffusion model based on the first plurality of noisy samples; constructing a second plurality of noisy samples by randomly sampling from a predetermined Gaussian noise distribution; inputting the second plurality of noisy samples into the trained diffusion model; and using the trained diffusion model to generate each respective one of a plurality of synthetic time series by applying a denoising function to the second plurality of noisy samples.

The training of the diffusion model may include minimizing a predetermined loss function.

The method may further comprise including at least one known fixed-point value with the second plurality of noisy samples.

The method may further include: measuring an amount by which each respective one of the plurality of synthetic time series violates a first constraint from among the at least one constraint; using the measured amount to determine a penalty function; and applying the penalty function to at least one from among the training of the diffusion model and the applying of the denoising function to the second plurality of noisy samples.

The method may further include obtaining a quality metric that relates to at least one from among a realism of the first synthetic time series, a distributional similarity between the first synthetic time series and the sample of the first historical time series, and a usefulness of the first synthetic time series.

The quality metric may include at least one from among a percentage error distance, a satisfaction rate, an inference time, and a fine-tuning time.

According to another exemplary embodiment, a computing apparatus for generating synthetic time series data is provided. The computing apparatus includes a processor; a memory; and a communication interface coupled to each of the processor and the memory. The processor is configured to: receive, via the communication interface, first information that relates to a sample of a first historical time series and second information that relates to at least one constraint; obtain a plurality of synthetic time series based on the first information and the second information; calculate a set of distances of respective differences between the first historical time series and each respective one of the plurality of synthetic time series; and select, from among the plurality of synthetic time series, a first synthetic time series for which a corresponding distance is a maximum among the calculated set of distances.

The at least one constraint may include at least one from among a trend constraint, a final value constraint, a global minimum constraint, and a multivariate constraint that relates to maximum and minimum values of each of a high dimension and a low dimension of the plurality of synthetic time series.

The processor may be further configured to obtain the plurality of synthetic time series by generating each respective one of the plurality of synthetic time series by using a Sequential Least Squares Programming algorithm.

According to yet another exemplary embodiment, a computing apparatus for generating synthetic time series data is provided. The computing apparatus includes a processor; a memory; and a communication interface coupled to each of the processor and the memory. The processor is configured to: receive, via the communication interface, first information that relates to a sample of a first historical time series and second information that relates to at least one constraint; add Gaussian noise to the sample of the first historical time series in order to generate a first plurality of noisy samples; train a diffusion model based on the first plurality of noisy samples; construct a second plurality of noisy samples by randomly sampling from a predetermined Gaussian noise distribution; input the second plurality of noisy samples into the trained diffusion model; and use the trained diffusion model to generate each respective one of a plurality of synthetic time series by applying a denoising function to the second plurality of noisy samples.

The processor may be further configured to perform the training of the diffusion model by minimizing a predetermined loss function.

The processor may be further configured to include at least one known fixed-point value with the second plurality of noisy samples.

The processor may be further configured to: measure an amount by which each respective one of the plurality of synthetic time series violates a first constraint from among the at least one constraint; use the measured amount to determine a penalty function; and apply the penalty function to at least one from among the training of the diffusion model and the applying of the denoising function to the second plurality of noisy samples.

The processor may be further configured to obtain a quality metric that relates to at least one from among a realism of the first synthetic time series, a distributional similarity between the first synthetic time series and the sample of the first historical time series, and a usefulness of the first synthetic time series.

The quality metric may include at least one from among a percentage error distance, a satisfaction rate, an inference time, and a fine-tuning time.

According to yet another exemplary embodiment, a non-transitory computer readable storage medium storing instructions for generating synthetic time series data is provided. The storage medium includes executable code which, when executed by a processor, causes the processor to: receive first information that relates to a sample of a first historical time series and second information that relates to at least one constraint; obtain a plurality of synthetic time series based on the first information and the second information; calculate a set of distances of respective differences between the first historical time series and each respective one of the plurality of synthetic time series; and select, from among the plurality of synthetic time series, a first synthetic time series for which a corresponding distance is a maximum among the calculated set of distances.

The at least one constraint may include at least one from among a trend constraint, a final value constraint, a global minimum constraint, and a multivariate constraint that relates to maximum and minimum values of each of a high dimension and a low dimension of the plurality of synthetic time series.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for generating synthetic time series data that is subject to various types of constraints.

FIG. 4 is a flowchart of an exemplary process for implementing a method for generating synthetic time series data that is subject to various types of constraints.

FIG. 5 is a flowchart of an exemplary process for using a diffusion model in an execution of a method for generating synthetic time series data that is subject to various types of constraints.

FIG. 6, FIG. 7, FIG. 8, FIG. 9, and FIG. 10 are algorithms that are usable in an execution of a method for generating synthetic time series data that is subject to various types of constraints, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

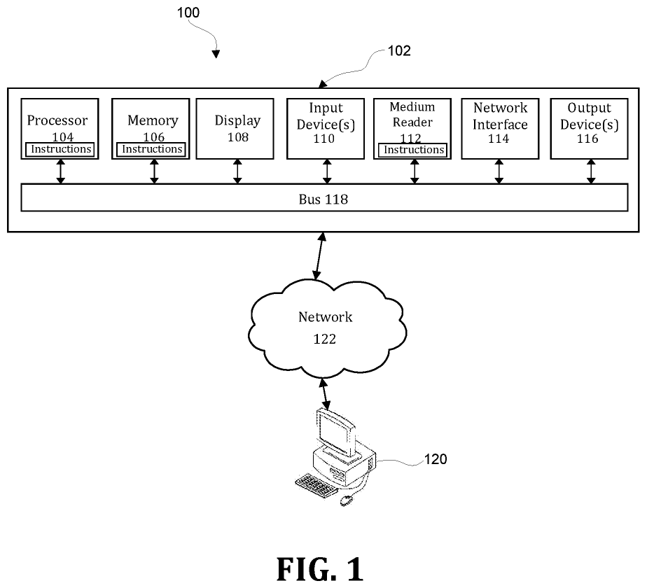

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for generating synthetic time series data that is subject to various types of constraints.

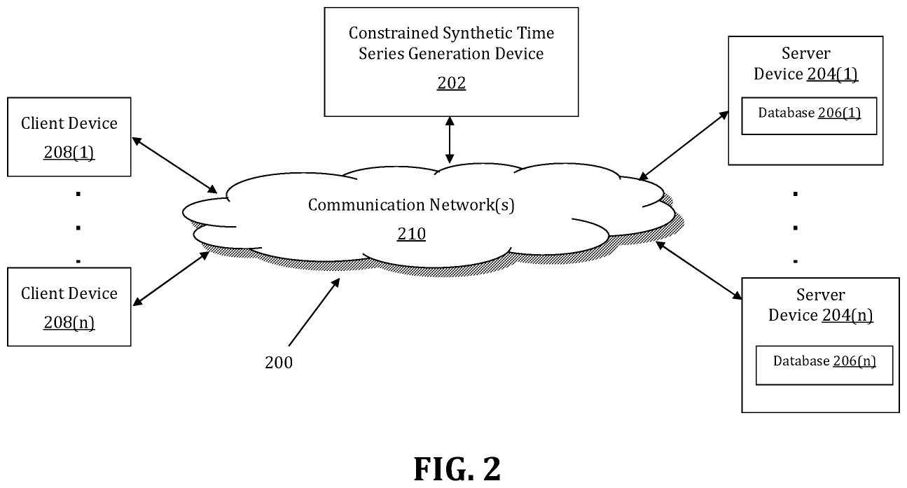

Referring to FIG. 2, a schematic of an exemplary network environment 200 for implementing a method for generating synthetic time series data that is subject to various types of constraints is illustrated. In an exemplary embodiment, the method is executable on any networked computer platform, such as, for example, a personal computer (PC).

The method for generating synthetic time series data that is subject to various types of constraints may be implemented by a Constrained Synthetic Time Series Generation (CSTSG) device 202. The CSTSG device 202 may be the same or similar to the computer system 102 as described with respect to FIG. 1. The CSTSG device 202 may store one or more applications that can include executable instructions that, when executed by the CSTSG device 202, cause the CSTSG device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CSTSG device 202 itself, may be located in virtual server(s) running in a cloud-based computing environment rather than being tied to one or more specific physical network computing devices. Also, the application(s) may be running in one or more virtual machines (VMs) executing on the CSTSG device 202. Additionally, in one or more embodiments of this technology, virtual machine(s) running on the CSTSG device 202 may be managed or supervised by a hypervisor.

In the network environment 200 of FIG. 2, the CSTSG device 202 is coupled to a plurality of server devices 204(1)-204(n) that hosts a plurality of databases 206(1)-206(n), and also to a plurality of client devices 208(1)-208(n) via communication network(s) 210. A communication interface of the CSTSG device 202, such as the network interface 114 of the computer system 102 of FIG. 1, operatively couples and communicates between the CSTSG device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CSTSG device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and CSTSG devices that efficiently implement a method for generating synthetic time series data that is subject to various types of constraints.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CSTSG device 202 may be a standalone device or integrated with one or more other devices or apparatuses, such as one or more of the server devices 204(1)-204(n), for example. In one particular example, the CSTSG device 202 may include or be hosted by one of the server devices 204(1)-204(n), and other arrangements are also possible. Moreover, one or more of the devices of the CSTSG device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CSTSG device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store historical time series data and data that relates to metrics for synthetic time series data quality.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CSTSG device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CSTSG device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the CSTSG device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CSTSG device 202, the server devices 204(1)-204(n), or the client devices 208(1)-208(n), for example, may be configured to operate as virtual instances on the same physical machine. In other words, one or more of the CSTSG device 202, the server devices 204(1)-204(n), or the client devices 208(1)-208(n) may operate on the same physical device rather than as separate devices communicating through communication network(s) 210. Additionally, there may be more or fewer CSTSG devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the internet, intranets, and combinations thereof.

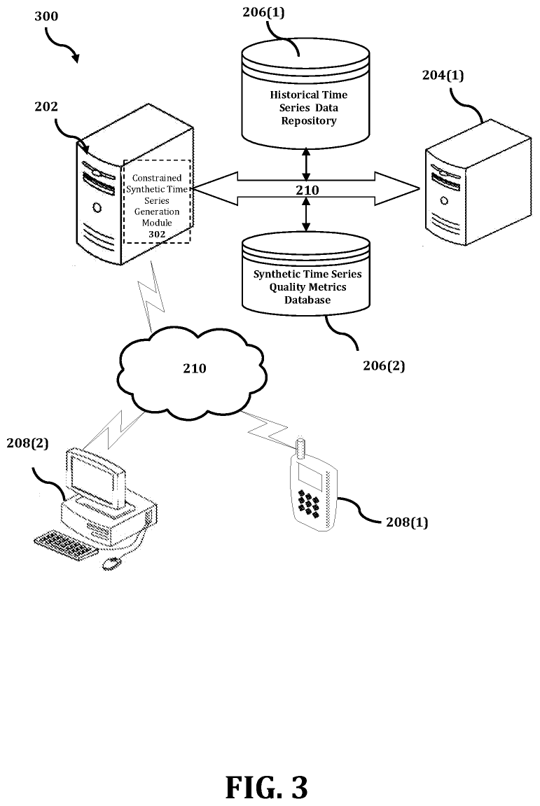

The CSTSG device 202 is described and illustrated in FIG. 3 as including a constrained synthetic time series generation module 302, although it may include other rules, policies, modules, databases, or applications, for example. As will be described below, the constrained synthetic time series generation module 302 is configured to implement a method for generating synthetic time series data that is subject to various types of constraints.

An exemplary process 300 for implementing a mechanism for generating synthetic time series data that is subject to various types of constraints by utilizing the network environment of FIG. 2 is illustrated as being executed in FIG. 3. Specifically, a first client device 208(1) and a second client device 208(2) are illustrated as being in communication with CSTSG device 202. In this regard, the first client device 208(1) and the second client device 208(2) may be “clients” of the CSTSG device 202 and are described herein as such. Nevertheless, it is to be known and understood that the first client device 208(1) and/or the second client device 208(2) need not necessarily be “clients” of the CSTSG device 202, or any entity described in association therewith herein. Any additional or alternative relationship may exist between either or both of the first client device 208(1) and the second client device 208(2) and the CSTSG device 202, or no relationship may exist.

Further, CSTSG device 202 is illustrated as being able to access a historical time series data repository 206(1) and a synthetic time series quality metrics database 206(2). The constrained synthetic time series generation module 302 may be configured to access these databases for implementing a method for generating synthetic time series data that is subject to various types of constraints.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the CSTSG device 202 via broadband or cellular communication. Of course, these embodiments are merely exemplary and are not limiting or exhaustive.

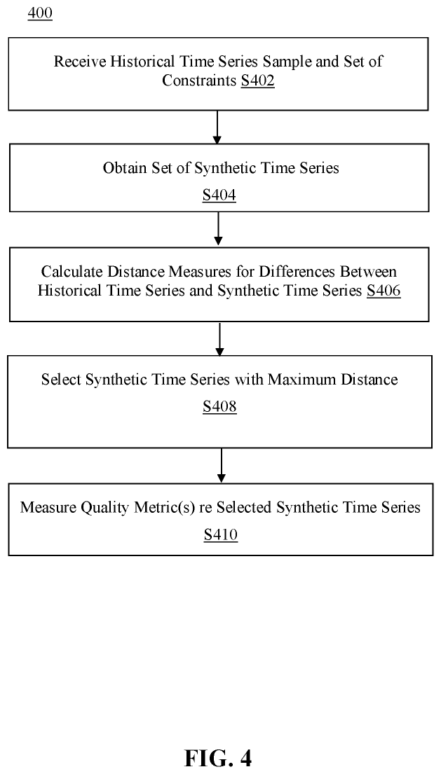

Upon being started, the constrained synthetic time series generation module 302 executes a process for generating synthetic time series data that is subject to various types of constraints. An exemplary process for generating synthetic time series data that is subject to various types of constraints is generally indicated at flowchart 400 in FIG. 4.

In process 400 of FIG. 4, at step S402, the constrained synthetic time series generation module 302 receives first information that relates to a sample of a historical time series and second information that relates to at least one constraint. In an exemplary embodiment, the historical time series may include any real time series data that is usable as a “seed” for the synthetic time series data to be generated. In an exemplary embodiment, the constraints are provided by a user, and may include any one or more of a trend constraint that relates to a predetermined curve that approximates a trend of the time series; a final value constraint that relates to a requirement that the final value of the time series is held to a specific predetermined value; a global minimum constraint that relates to a predetermined time point at which a minimum value of the time series must occur; and a multivariate constraint that relates to maximum and minimum values of each of a high dimension and a low dimension of the time series.

At step S404, the constrained synthetic time series generation module 302 obtains a plurality of synthetic time series based on the first information and second information received in step S402. In an exemplary embodiment, the plurality of synthetic time series may be obtained by generating each respective synthetic time series by using a Sequential Least Squares Programming Algorithm.

At step S406, the constrained synthetic time series generation module 302 calculates a set of distance measures, such as, for example, L2 norms, for respective differences between each respective one of the plurality of synthetic time series obtained in step S404 and the historical time series sample received in step S402. Then, at step S408, the constrained synthetic time series generation module 302 selects the synthetic time series that corresponds to the maximum distance.

At step S410, the constrained synthetic time series generation module 302 measures one or more quality metrics with respect to the synthetic time series. In an exemplary embodiment, each such quality metric relates to at least one from among a realism of the selected synthetic time series, a distributional similarity between the selected synthetic time series and the sample of the first historical time series, and a usefulness of the selected synthetic time series. In an exemplary embodiment, the quality metric may include at least one from among a percentage error distance, a satisfaction rate, an inference time, and a fine-tuning time.

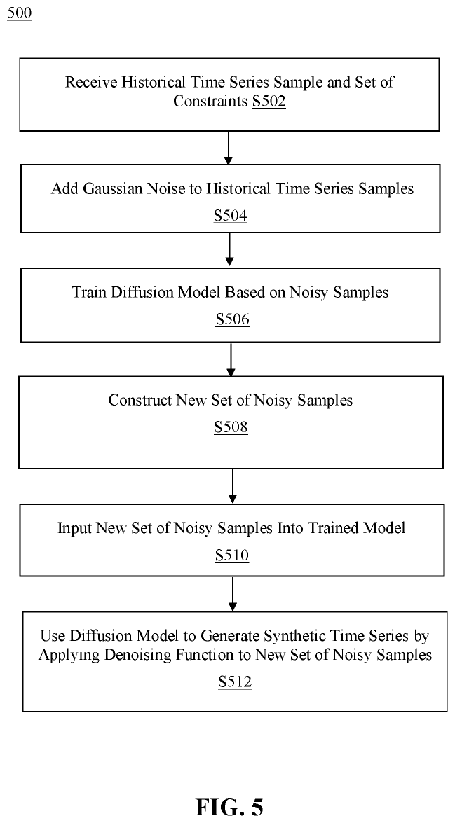

FIG. 5 is a flowchart 500 of an exemplary process for using a diffusion model in an execution of a method for generating synthetic time series data that is subject to various types of constraints. In process 500 of FIG. 5, at step S502, similarly as in step S402, the constrained synthetic time series generation module 302 receives first information that relates to a sample of a historical time series and second information that relates to at least one constraint. Then, in step S504, the constrained synthetic time series generation module 302 adds Gaussian noise to the sample of the historical time series received in step S502, in order to generate a first set of noisy samples. In step S506, the constrained synthetic time series generation module 302 trains the diffusion model based on the first set of noisy samples. In step S508, the constrained synthetic time series generation module 302 constructs a second set of noisy samples by randomly sampling from a predetermined Gaussian noise distribution, and then, in step S510, the constrained synthetic time series generation module 302 inputs the second set of noisy samples into the trained diffusion model. In step S512, the constrained synthetic time series generation module 302 uses the trained diffusion model to generate each respective one of a plurality of synthetic time series by applying a denoising function to the second set of noisy samples. In an exemplary embodiment, the diffusion model may be a deep neural network (DNN) model.

Synthetic time series are often used in practical applications to augment the historical time series dataset to improve performance of machine learning algorithms, amplify the occurrence of rare events, and also create counterfactual scenarios described by the time series. Distributional similarity (also referred to herein as “realism”), and also the satisfaction of certain numerical constraints, are common requirements in counterfactual time series scenario generation requests. For instance, the US Federal Reserve publishes synthetic market stress scenarios given by the constrained time series for financial institutions to assess their performance in hypothetical recessions. Conventional approaches for generating constrained time series usually penalize training loss to enforce constraints, and reject non-conforming samples. However, such approaches would require re-training when constraints are changed, and rejection sampling can be computationally expensive, or impractical for complex constraints.

In an exemplary embodiment, a set of methods for talking the constrained time series generation problem is provided, and efficient sampling while ensuring the realism of the generated time series is also provided. The problem is framed using a constrained optimization framework, and then a set of generative methods is described, including the use of a guided diffusion model to generate realistic synthetic time series.

The constrained time series generation problem requires generating synthetic time series data, where each time series is defined in a sample space χ= [symbol] ^{L×K} where L is the length of the time series and K is the number of features. In an exemplary embodiment, a goal is to generate synthetic data such that the synthetic distribution approximates the input data distribution, and each time series also conforms to user-specified constraints. The problem input [symbol] [symbol] ={xⁱ}ᵢ₌₁^{N}, C [symbol] that consists of a dataset D of N time series xⁱ∈χ, i∈[1 . . . N] and a list of constraints C that a synthetic time series should conform to. The constraints include realism constraints. The following definitions are also used herein: [K]≙{0, . . . , K} and [L]≙{0, . . . , L}.

Constraints are defined as tuples of the form [symbol] t,ƒ [symbol] ∈C, where can be either soft or hard and a differentiable function f. If the constraint type is hard, then f can be an inequality or an equality constraint. An inequality constraint is of the form ƒ(\hat{x})≤0 where \hat{x} is the generated synthetic time series. An equality constraint is of the form ƒ(\hat{x})=0. Hard constraints are required to hold in a generated time series; otherwise, the time series is rejected. Soft constraints are of the form ƒ:χ→ [symbol] whose value it is desired to optimize and/or minimize for. Therefore, by definition, soft constraints do not require sample rejection. The constraints can be defined with respect to individual synthetic time series samples \hat{x}, or at the dataset level (i.e., distribution-related constraints). As a type of soft constraint, trend-lines are defined as a time series S∈χ. This constraint tells a generative method to minimize the L2 distance between the trend and the corresponding points of the synthetic time series. Formally, the synthetic time series \hat{x} would be optimized as to minimize ∥s−\hat{x}∥₂².

Additionally, both soft and hard constraints can be categorized into local and global constraints. Global constraints are those that compare across all points in the time series. For example, it can be enforced that x_{i,j}≤x_{3,0}, ∀(i,j)∈[L]×[K] such that the maximum value is at x_{3,0}. Local constraints are those that refer only to a subset of points. For instance, requiring (x_{i,j}=2.5) for a given point (i,j)∈[L]×[K]. This kind of constraint may be referred to as a fixed-point constraint, because it requires that the value of the time series is fixed at that point to a specific value. The set of all fixed-point constraints is [symbol] , where each element r_{i,j}∈ [symbol] and (i,j)∈[L]×[K].

The aforementioned types of constraints are explicit. Additionally, the problem of synthetic data generation requires statistical similarity between the input and the synthetic datasets, which can either be built-in into the data generating method, or specified explicitly as constraints in the model. In an exemplary embodiment, the methods described below assume that the constraints are differentiable. This is needed for deep generative methods, such as diffusion models, where constraints need to be incorporated into the training or inference process. If the functions are differentiable, then Expression 1 provide a straightforward approach for incorporating these functions into the loss:

$$loss ( x , \hat{x} ) = objective\_loss ( x , \hat{x} ) + {λ}_{g} ReLU ( g ( \hat{x} ) ) + {λ}_{h} {h ( \hat{x} )}^{2} , \qquad ( Expression 1 )$$

where g(\hat{x}) and h(\hat{x}) are the inequality and an equality constraint respectively, which are added as soft constraints into the loss function with penalty terms λ_{g} and λₕ. However, incorporating constraints into the loss function may not guarantee constraint-conforming solutions, but good candidate or starting solutions that can then be fine-tuned, i.e., adjusted to guarantee constraints. If the constraints are not differentiable, then one can use approaches that compute the loss for such a “rule” using perturbations.

In an exemplary embodiment, a first model tackles the synthetic time series generation problem as a Constrained Optimization Problem (COP) in which each point x_{i,j}∈x is treated as a decision variable to be optimized. A COP problem is defined by an objective function for which a solution is optimized and by a set of constraints that need to be satisfied by the solution.

COP can be used in two ways, one as a generative method, and the other as a fine-tuning method. If COP is used for generating a synthetic time series, then as an input, a sample real time series x from D is taken as a “seed” for generation, and an objective is set to maximize the difference between the seed and the synthetic time series. Formally, the L2 norm of the time series is maximized: obj(x,\hat{x})=∥x−\hat{x}∥₂, where x is the seed time series and \hat{x} is the generated synthetic time series. It is noted that the L2 norm is an exemplar function that is a measure of difference or distance between two samples; however, in an exemplary embodiment, any suitable type of distance measure can be used for addressing the objective of maximizing the difference between the seed and the synthetic time series. COP can also be used for fine-tuning candidate solutions generated by other methods, such as by a diffusion model. When using COP as a fine-tuning method, the candidate solution generated by the other method becomes the seed time series, and the objective simply changes from maximizing the distance to minimizing the distance, i.e., to preserve the information from the candidate time series and just search in the space of nearby solutions for one that satisfies all the constraints, if any failed. This can be helpful in fixing almost-correct solutions, rather than using rejection sampling.

The constraints for the COP formulation come from C. Additionally, when using COP as a generative process, there is a need to add constraints to satisfy certain desired distributional properties, such as preserving the distribution of the autocorrelation of returns for stock data. This is done by constraining the COP solver to try and match the desired property of the seed time series; by matching the property at the sample level, there is an intention to match the distribution of that property at the dataset level. This is done by computing the target value from the seed time series and comparing it with the corresponding value from the synthetic time series. Specifically, the COP is constrained to limit the magnitude of the error between the property value computed for \hat{x} and x within an allowed amount, i.e., a budget for error tolerance. This is done by using an inequality constraint as follows: e(z(\hat{x}),z(x))−b≤0, where b is the budget, z(·) is the function that computes the desired property, and e(·) is the error function that measures the error between the target and generated values. For example, for autocorrelation of returns in stock data, the time series property is a vector, so the error function is the L2-norm of the difference. If the COP solver cannot find a solution within the allowed error tolerance, the budget is increased (for example, the budget may be doubled), and the process is repeated for up to a fixed number of repeats.

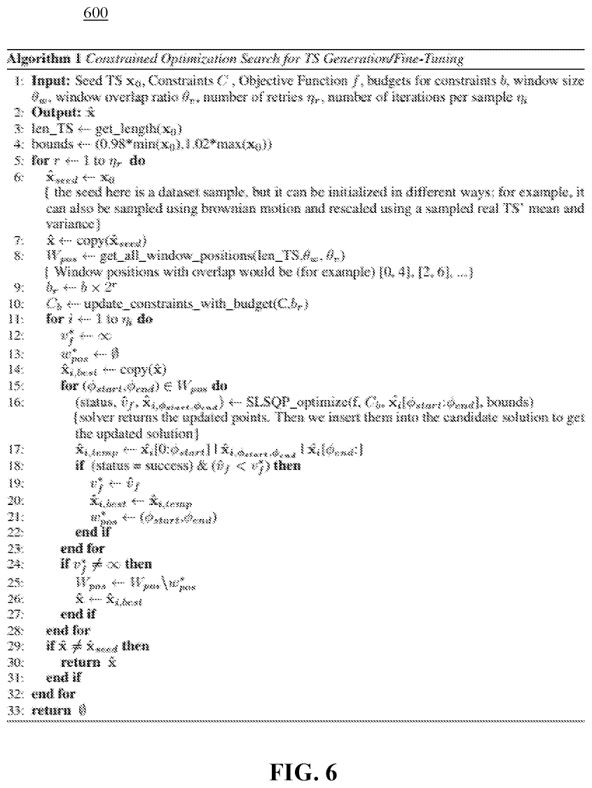

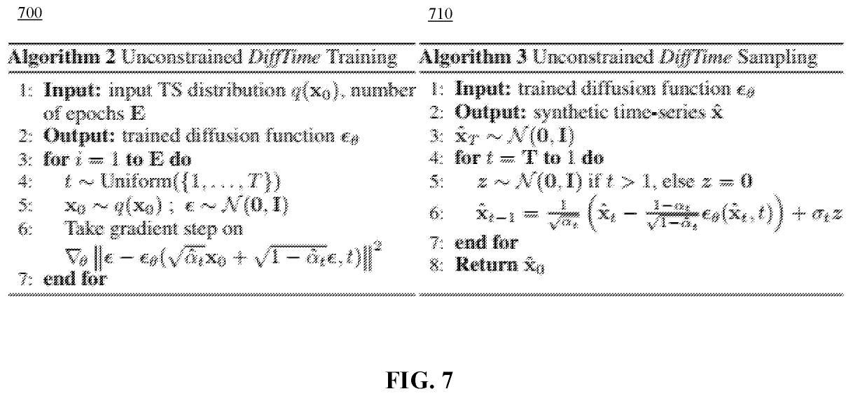

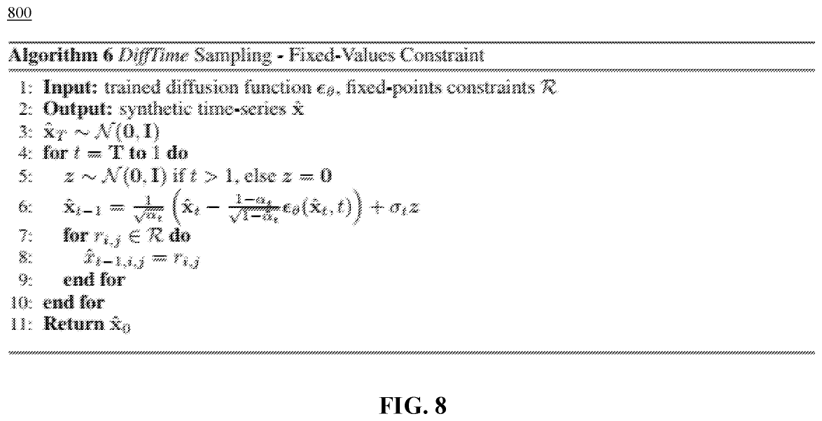

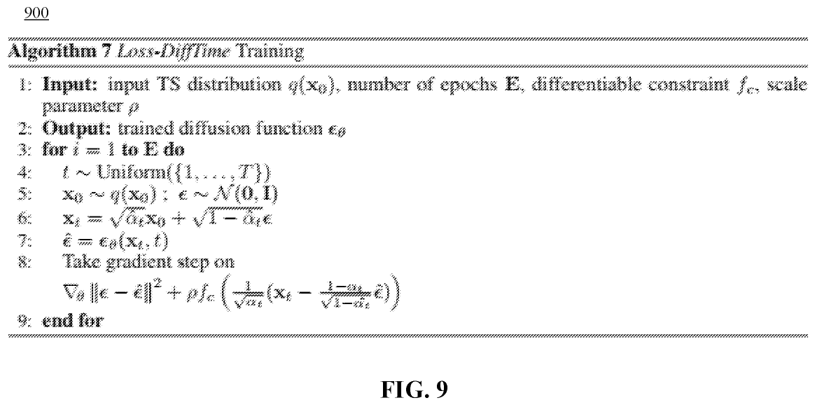

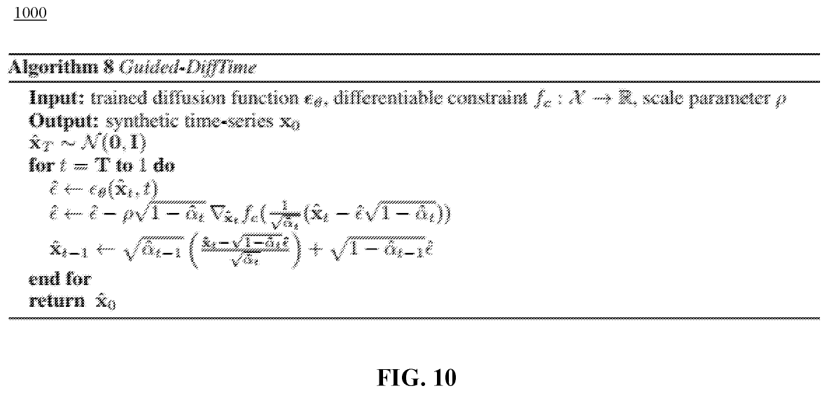

In an exemplary embodiment, once the objective function and constraints are defined for COP, any one of many available solvers may be used to compute the synthetic time series. For example, the Sequential Least Squares Programming (SLSQP) solver may be used for computing the synthetic time series. FIG. 6 is an algorithm 600 that is usable with respect to COP in an execution of a method for generating synthetic time series data that is subject to various types of constraints, according to an exemplary embodiment.

As described above, the use of COP for generating synthetic time series while guaranteeing the input constraints and data properties represents one approach to the problem. However, such COP problems may be non-linear, and solving a non-linear problem is in general difficult and computationally expensive, especially with multi-variate and long time series. In another exemplary embodiment, a conditional diffusion model referred to herein as DiffTime is designed to leverage various advancements in score-based diffusion models in order to generate synthetic time series. The DiffTime model is designed to generate realistic time series and to cope with trend and fixed-point constraints by conditioning the generative model.

Denoising Diffusion models are latent variable models which are trained to generate samples by gradually removing noise, i.e., denoising, from samples corrupted by Gaussian noise. These models approximate a real data distribution q(x₀) by learning a model distribution p_{θ}(x₀):=∫p_{θ}(x_{0:T})dx_{1:T}, where the latent variables x_{1:T} are defined in the same space of the sample x₀. The training follows 1) a forward process that progressively adds noise to the sample x₀, and 2) a reverse process where the generative process gradually denoises a noisy observation. The forward process is described with the following Markov chain as shown below in Expression 2, with Gaussian transitions parameterized by β_{1:T}.

$$q ( {x}_{1 : T} \vert {x}_{0} ) := {\prod }_{t = 1}^{T} q ( {x}_{t} \vert {x}_{t - 1} ) , \qquad ( Expression 2 )$$

$$q ( {x}_{t} \vert {x}_{t - 1} ) := 𝒩 ( \sqrt{1 - {β}_{t}} {x}_{t - 1} , {β}_{t} I ) .$$

Expression 2 admits the following close form q(xₜ|x₀)= [symbol] (xₜ; \sqrt{αₜ}x₀, (1−αₜ)I), where αₜ:=1−βₜ and αₜ:=Πᵢ₌₁^{t}αᵢ, which allows sampling xₜ at any arbitrary diffusion step t. The generation is performed by the reverse process defined as a Markov chain as shown in Expression 3, starting at p(x_{T})= [symbol] (x_{T};0,I):

$${p}_{θ} ( {x}_{0 : T} ) := p ( {x}_{T} ) {\prod }_{t = 1}^{T} {p}_{θ} ( {x}_{t - 1} \vert {x}_{t} ) , \qquad ( Expression 3 )$$

$${p}_{θ} ( {x}_{t - 1} \vert {x}_{t} ) := 𝒩 ( {x}_{t - 1} : {μ}_{θ} ( {x}_{t} , t ) , {Σ}_{θ} ( {x}_{t} , t ) ) .$$

In an exemplary embodiment, the reverse process is parameterized as shown in Expression 4:

$${μ}_{θ} ( {x}_{t} , t ) = \frac{1}{\sqrt{{\hat{α}}_{t}}} ( {x}_{t} - \frac{{β}_{t}}{\sqrt{1 - {\hat{α}}_{t}}} {ϵ}_{θ} ( {x}_{t} , t ) ) , \qquad ( Expression 4 )$$

$${Σ}_{θ} ( {x}_{t} , t ) = {σ}^{2} I , where {σ}^{2} = \sqrt{{β}_{t}} ,$$

where ϵ_{θ} is a trainable denoising function that predicts ϵ from xₜ, and the choice of β corresponds to the upper bound on the reverse process entropy. This function is approximated through a deep neural network trained according to an objective as shown below in Expression 5:

$$L ( θ ) := {𝔼}_{t , {x}_{0} , ϵ} {‖ ϵ - {ϵ}_{θ} ( \sqrt{{\hat{α}}_{t}} {x}_{0} + \sqrt{1 - {\hat{α}}_{t}} ϵ , t ) ‖}^{2} ,$$

where t is uniformly sampled between 1 and T, and the noise is Gaussian ϵ˜ [symbol] (0,I). The diffusion steps T and variances βₜ control the expressiveness of [symbol] the diffusion process and they are important hyperparameters to guarantee that the forward and reverse processes have the same functional form.

In an exemplary embodiment, the DiffTime model, which is a conditional diffusion model, supports both trend and fixed point constraints. To constrain a particular trend, the diffusion process is conditioned by using a trend time series s∈χ. In an exemplary embodiment, a model distribution is defined as shown in Expression 6:

$${p}_{θ} ( {x}_{0 : T} \vert s ) := p ( {x}_{T} ) {\prod }_{t = 1}^{T} {p}_{θ} ( {x}_{t - 1} \vert {x}_{t} , s ) , \qquad ( Expression 6 )$$

$${p}_{θ} ( {x}_{t - 1} \vert {x}_{t} , s ) := 𝒩 ( {x}_{t - 1} : {μ}_{θ} ( {x}_{t} , t \vert s ) , {Σ}_{θ} ( {x}_{t} , t \vert s ) ) ,$$

which is learned by extending the parameterization in Expression 4 with a conditional denoising function as shown below in Expression 7:

$${μ}_{θ} ( {x}_{t} , t \vert s ) = \frac{1}{\sqrt{{\hat{α}}_{t}}} ( {x}_{t} - \frac{{β}_{t}}{\sqrt{1 - {\hat{α}}_{t}}} {ϵ}_{θ} ( {x}_{t} , t \vert s ) ) ,$$

where the Σ_{θ}(xₜ,t|s)=σ²I. In this formulation, the trend is provided during each diffusion step t, without any noise added to the conditioning trend. During the training, the trend s is extracted directly from the input time series x₀, which can be a simple linear or polynomial interpolation; during inference, the trend can be defined by the user at inference time. As described above, this is a soft constraint, meaning that it is not expected that the generated time series will exactly retrace the trend. In particular, during training, a trend that is a low-order polynomial approximation of x₀ is provided in order to avoid the model from copying the trend s.

Thus, the DiffTime training procedure minimizes the following revised loss function as shown in Expression 8:

$$L ( θ ) := {𝔼}_{t , {x}_{0} , ϵ} {‖ ϵ - {ϵ}_{θ} ( \sqrt{{\hat{α}}_{t}} {x}_{0} + \sqrt{1 - {\hat{α}}_{t}} ϵ , t \vert s ) ‖}^{2} . \qquad ( Expression 8 )$$

In an exemplary embodiment, in order to satisfy fixed point constraints, which are hard constraints, the reverse process of DiffTime is modified to explicitly include the fixed point constraints in the latent variables x_{1:T}. Recall that [symbol] is the set of fixed point constraints, such that a fixed point constraint τ_{i,j}∈ [symbol] with (i,j)∈[L]×[K]. Thus, at each diffusion step t, there is an explicit enforcement of the fixed-points values in the noisy time series xₜ, such that ∀r_{i,j}∈ [symbol] , x_{i,j}=τ_{i,j}, where x_{i,j}∈xₜ. This approach would guarantee that the generated time series have the desired fixed-point values. Most importantly, experimental results have validated that the forward process generates consistent neighboring points around the constrained fixed points, which means that the synthetic samples are conditioned by the fixed points, and also preserves the realism of the original input data. During training, the fixed points are randomly sampled from the input time series (x₀) and the diffusion process is required to conform to those fixed points. At inference, the fixed points can be provided by the user. FIG. 7 illustrates two algorithms 700 and 710 that are usable with respect to DiffTime in an execution of a method for generating synthetic time series data that is subject to various types of constraints, according to an exemplary embodiment. FIG. 8 is another algorithm 800 that is usable with respect to DiffTime in an execution of a method for generating synthetic time series data that is subject to various types of constraints, according to an exemplary embodiment.

In DiffTime, conditional diffusion models are leveraged to support trend and fixed values for generating time series. However, just conditioning the model generation is not sufficient to encode all the constraints. A common solution is to penalize the generative model proportionally to how much the generated time series violates the input constraint.

In an exemplary embodiment, another model is referred to herein as Loss-DiffTime, where a constraint penalty is applied to deal with any kind of constraint. The penalty function ƒ_{c}:X→ [symbol] is added to the learning objective of the diffusion model, and it evaluates whether the generated time series \hat{x} meets the input constraint. With the penalty function f_{c} in the loss, the greater the constraint violation is, the greater the model loss during training will be. However, the optimization problem in Expression 5 predicts the noise component for the sample x₀, into which it is not possible to directly feed to the penalty function. Moreover, it is not possible to apply f_{c}(x) to a noisy sample xₜ as the constraints may be evaluated only on the final sample. Therefore, to apply the penalty function, the optimization problem is re-parameterized in order to force the diffusion model to explicitly model the final sample \hat{x}₀ at every step, as shown in Expression 9:

$$L ( θ ) := {𝔼}_{t , {x}_{0} , ϵ} [ {‖ ϵ - {ϵ}_{θ} ( {x}_{t} , t \vert s ) ‖}^{2} + ρ {f}_{c} ( {\hat{x}}_{0} ) ] ,$$

$$where {x}_{t} = \sqrt{{\hat{α}}_{t}} {x}_{0} + \sqrt{1 - {\hat{α}}_{t}} ϵ and$$

$${\hat{x}}_{0} = \frac{1}{\sqrt{{α}_{t}}} ( {x}_{t} - \frac{1 - {α}_{t}}{\sqrt{1 - {\hat{α}}_{t}}} {ϵ}_{θ} ( {x}_{t} , t ) ) .$$

It is considered that any constraint in C can be differentiable. Thus, it is possible to train the diffusion model following Expression 9 where ρ is a scale parameter used to adjust the importance of the constraint loss. The conditional information of the trend s can be removed if there is no need to enforce any trend constraint. FIG. 9 is an algorithm 900 that is usable with respect to Loss-DiffTime in an execution of a method for generating synthetic time series data that is subject to various types of constraints, according to an exemplary embodiment.

The Loss-DiffTime model is now able to generate real time series while dealing with any constraint. However, there are two major drawbacks: 1) Because constraints are translated to penalty terms in the loss, there is a need to re-train the model for new constraints; and 2) the diffusion models usually require several iterative steps T which can make it slower and relatively expensive for time series generation. In an exemplary embodiment, another model is referred to a Guided-DiffTime, and this model solves these two problems and can dramatically reduce the carbon footprint when using deep generative models (DGM) for constrained time series generation. In particular, Guided-DiffTime adopts a Denoising Diffusion Implicit Model (DDIM) which requires fewer diffusion steps at inference. Moreover, by guiding a diffusion model using a noisy classifier, a pre-trained diffusion model can be guided using gradients from differentiable constraints.

DDIM is a class of non-Markovian diffusion processes with the same training objective of classic Denoising Diffusion Probabilistic Models (DDPMs), but fewer diffusion steps to generate high-quality samples are required. In particular, DDIMs use the same training procedure as described above, while the sampling can be accelerated by using the following re-parameterization of the reverse process as shown in Expression 10 below:

$${x}_{t - 1} = \sqrt{{\hat{α}}_{t - 1}} ( \frac{{x}_{t} - \sqrt{1 - {\hat{α}}_{t}} \cdot {ϵ}_{θ} ( {x}_{t} , t )}{\sqrt{{\hat{α}}_{t}}} ) + \sqrt{1 - {\hat{α}}_{t - 1} - {σ}_{t}^{2}} \cdot {ϵ}_{θ} ( {x}_{t} , t ) + {σ}_{t} ϵ , \qquad ( Expression 10 )$$

\hat{α}₀:=1 where and different parameterizations of σₜ lead to different generative processes. The definition of σₜ=0, ∀t∈[0,T] provides a deterministic forward process from latent variables to the sample x₀, because the noise term σₜϵ is zeroed out. This deterministic forward process defines the DDIM which can use fewer diffusion steps to generate realistic samples. These diffusion steps are defined by a sequence τ of length V which is a sub-sequence of [1, . . . T] with the last value as T, i.e., τ_{V}=T. For example, τ=[1, 4, 9, . . . T]. Moreover, this parameterization is a generalization of DDPM as setting σₜ=\sqrt{(1−αₜ₋₁)/(1−αₜ)} \sqrt{1−αₜ/αₜ₋₁} describes the original DDPM, and it has been found that re-training of the DDPM model is unnecessary when the value of f_{c} or the diffusion steps T are changed.

FIG. 10 is an algorithm 1000 that is usable with respect to Guided-DiffTime in an execution of a method for generating synthetic time series data that is subject to various types of constraints, according to an exemplary embodiment.

Given the DDIM, results from guided diffusion models can be applied to condition each sampling step with the information given by the gradients of the differentiable constraint f_{c}. Referring to FIG. 10, algorithm 1000 shows the sampling procedure which computes the gradients with respect to the input time series xₜ. As described above, the constraint is applied on the final sample \hat{x}₀, computed according to the DDIM reverse process. As also described above, this approach does not require re-training of the original diffusion model to deal with new constraints, which can be applied just at inference time. Hence, there is a corresponding reduction of the carbon footprint of the model, and a faster time-series generation is also a result.

Evaluation metrics: In an exemplary embodiment, the generative models and the synthetic time series can be evaluated along different quantitative and qualitative dimensions. First, a realism quality can be evaluated through a discriminative score, which measures how much the generated samples resemble (i.e., are indistinguishable from) the real data using a post-hoc recurrent neural network (RNN) that is trained to distinguish between real and generated samples. Second, an evaluation of a distributional-similarity quality between the synthetic data and real data can be made by applying t-stochastic neighbor embedding (t-SNE) on both real and synthetic samples; in a two-dimensional space, t-SNE shows how well the synthetic distribution covers the original input distribution. Third, an evaluation of a usefulness quality of generated samples, i.e., how the synthetic data supports a downstream task such as prediction, may be made by training an RNN on synthetic data and testing its prediction performance on real data, i.e., obtaining a predictive score. To evaluate how the model satisfies different constraints, the following metrics may be used: 1) Percentage error distance, which measures how much the synthetic data follows a trend constraint by evaluating the L2 distance between the time series and the trend; 2) satisfaction rate which measure the percentage of time that a synthetic time series meets the input constraints; 3) inference time measured as the average number of seconds required to generate a new sample with a given constraint; and 4) fine-tuning time which is the average amount of time, in seconds, that is need to enforce constraints over a generated sample, using COP to perform the fine-tuning operation.

Accordingly, with this technology, a process for generating synthetic time series data that is subject to various types of constraints is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating synthetic time series data, the method being implemented by at least one processor, the method comprising:
receiving, by the at least one processor, first information that relates to a sample of a first historical time series and second information that relates to at least one constraint;
obtaining, by the at least one processor, a plurality of synthetic time series based on the first information and the second information;
calculating, by the at least one processor, a set of distances of respective differences between the first historical time series and each respective one of the plurality of synthetic time series; and
selecting, by the at least one processor from among the plurality of synthetic time series, a first synthetic time series for which a corresponding distance is a maximum among the calculated set of distances.

2. The method of claim 1, wherein the at least one constraint includes at least one from among a trend constraint, a final value constraint, a global minimum constraint, and a multivariate constraint that relates to maximum and minimum values of each of a high dimension and a low dimension of the plurality of synthetic time series.

3. The method of claim 1, wherein the obtaining of the plurality of synthetic time series comprises generating each respective one of the plurality of synthetic time series by using a Sequential Least Squares Programming algorithm.

4. A method for generating synthetic time series data, the method being implemented by at least one processor, the method comprising:
receiving, by the at least one processor, first information that relates to a sample of a first historical time series and second information that relates to at least one constraint;
adding Gaussian noise to the sample of the first historical time series in order to generate a first plurality of noisy samples;
training a diffusion model based on the first plurality of noisy samples;
constructing a second plurality of noisy samples by randomly sampling from a predetermined Gaussian noise distribution;
inputting the second plurality of noisy samples into the trained diffusion model; and
using the trained diffusion model to generate each respective one of a plurality of synthetic time series by applying a denoising function to the second plurality of noisy samples.

5. The method of claim 4, wherein the training of the diffusion model comprises minimizing a predetermined loss function.

6. The method of claim 4, further comprising including at least one known fixed-point value with the second plurality of noisy samples.

7. The method of claim 4, further comprising:
measuring an amount by which each respective one of the plurality of synthetic time series violates a first constraint from among the at least one constraint;
using the measured amount to determine a penalty function; and
applying the penalty function to at least one from among the training of the diffusion model and the applying of the denoising function to the second plurality of noisy samples.

8. The method of claim 1, further comprising obtaining a quality metric that relates to at least one from among a realism of the first synthetic time series, a distributional similarity between the first synthetic time series and the sample of the first historical time series, and a usefulness of the first synthetic time series.

9. The method of claim 8, wherein the quality metric includes at least one from among a percentage error distance, a satisfaction rate, an inference time, and a fine-tuning time.

10. A computing apparatus for generating synthetic time series data, the computing apparatus comprising:
a processor;
a memory; and
a communication interface coupled to each of the processor and the memory,
wherein the processor is configured to:
receive, via the communication interface, first information that relates to a sample of a first historical time series and second information that relates to at least one constraint;
obtain a plurality of synthetic time series based on the first information and the second information;
calculate a set of distances of respective differences between the first historical time series and each respective one of the plurality of synthetic time series; and
select, from among the plurality of synthetic time series, a first synthetic time series for which a corresponding distance is a maximum among the calculated set of distances.

11. The computing apparatus of claim 10, wherein the at least one constraint includes at least one from among a trend constraint, a final value constraint, a global minimum constraint, and a multivariate constraint that relates to maximum and minimum values of each of a high dimension and a low dimension of the plurality of synthetic time series.

12. The computing apparatus of claim 10, wherein the processor is further configured to obtain the plurality of synthetic time series by generating each respective one of the plurality of synthetic time series by using a Sequential Least Squares Programming algorithm.

13. A computing apparatus for generating synthetic time series data, the computing apparatus comprising:
a processor;
a memory; and
a communication interface coupled to each of the processor and the memory,
wherein the processor is configured to:
receive, via the communication interface, first information that relates to a sample of a first historical time series and second information that relates to at least one constraint;
add Gaussian noise to the sample of the first historical time series in order to generate a first plurality of noisy samples;
train a diffusion model based on the first plurality of noisy samples;
construct a second plurality of noisy samples by randomly sampling from a predetermined Gaussian noise distribution;
input the second plurality of noisy samples into the trained diffusion model; and
use the trained diffusion model to generate each respective one of the plurality of synthetic time series by applying a predetermined denoising function to the second plurality of noisy samples.

14. The computing apparatus of claim 13, wherein the processor is further configured to perform the training of the diffusion model by minimizing a predetermined loss function.

15. The computing apparatus of claim 13, wherein the processor is further configured to include at least one known fixed-point value with the second plurality of noisy samples.

16. The computing apparatus of claim 13, wherein the processor is further configured to:
measure an amount by which each respective one of the plurality of synthetic time series violates a first constraint from among the at least one constraint;
use the measured amount to determine a penalty function; and
apply the penalty function to at least one from among the training of the diffusion model and the applying of the denoising function to the second plurality of noisy samples.

17. The computing apparatus of claim 10, wherein the processor is further configured to obtain a quality metric that relates to at least one from among a realism of the first synthetic time series, a distributional similarity between the first synthetic time series and the sample of the first historical time series, and a usefulness of the first synthetic time series.

18. The computing apparatus of claim 17, wherein the quality metric includes at least one from among a percentage error distance, a satisfaction rate, an inference time, and a fine-tuning time.

19. A non-transitory computer readable storage medium storing instructions for generating synthetic time series data, the storage medium comprising executable code which, when executed by a processor, causes the processor to:
receive first information that relates to a sample of a first historical time series and second information that relates to at least one constraint;
obtain a plurality of synthetic time series based on the first information and the second information;
calculate a set of distances of respective differences between the first historical time series and each respective one of the plurality of synthetic time series; and
select, from among the plurality of synthetic time series, a first synthetic time series for which a corresponding distance is a maximum among the calculated set of distances.

20. The storage medium of claim 19, wherein the at least one constraint includes at least one from among a trend constraint, a final value constraint, a global minimum constraint, and a multivariate constraint that relates to maximum and minimum values of each of a high dimension and a low dimension of the plurality of synthetic time series.
